(19) United States
(12) Patent Application Publication
(10) Pub. No.: US 2003/0059580 A1
(43) Pub. Date: Mar. 27, 2003

(54) Absorbent composite material, preparation and use in particular as industrial wiping article

(76) Inventors: Ralph Durand, Argenteuil (FR); Olivier Durand, Bois Guillaume (FR)

Correspondence Address: Nixon & Vanderhye, 8th Floor, 1100 North Glebe Road, Arlington, VA, 22201-4714, US

(21) Appl. No.: 10/149,758

(22) PCT Filed: Dec. 7, 2000
(86) PCT No.: PCT/FR00/03396

(51) Int. Cl. B32B 1/00; B05D 1/02

(52) U.S. Cl. 428/174; 427/421

(57) ABSTRACT

The present invention relates to composite materials and to wiping items having enhanced absorbing properties. It more specifically deals with absorbing composite materials consisting of a super-absorbing product placed between two or several cellulose wadding webs. The invention also relates to a method and to a device for preparing these wiping products or items, as well as to their uses, notably for the industrial wiping of various liquids (water, oil, fats, biological fluids, mixtures, etc.)

The present invention relates to composite products and materials notably used as wiping items, having enhanced absorbing properties. It also relates to a method and a device for preparing these wiping products or items, as well as to their uses, notably for the industrial wiping of various liquids (water, oil, fats, biological fluids, mixtures, etc.).

Presently available disposable wiping items essentially consist of one or several thicknesses of sheets (or webs) of fibrous material of the cellulose or viscose type, for example. In particular, these items may include 1 to 5 sheets, bound together mechanically and/or chemically. The absorbing power of these items is to a large extent determined by the number of sheets. While these items are suitable for domestic uses (handkerchiefs, paper towels, toilet paper, etc.), they are not however sufficiently suited for industrial wiping, i.e. of large surfaces, or of large volumes of liquids, because of their limited absorbing power. In addition, although the wiping products in non-woven fibers (of the viscose type) may have better absorbing power and higher mechanical strength, their cost is high and this limits their applications.

The present invention now describes novel composite products and materials, which may notably be used as wiping articles or products, having highly enhanced absorbing properties. These items may additionally be produced simply, industrially and economically. These novel articles and the methods and devices of the invention are particularly advantageous for any type of wiping, whether industrial or domestic, and are particularly suited for industrial wiping.

More specifically, a first object of the invention lies in an absorbing composite material, characterized in that it consists of a super-absorbing product placed between two or several cellulose wadding webs preferably bound together by full width mechanical embossing.

Another object of the invention lies in a wiping item, characterized in that it comprises, between at least two cellulose wadding webs, a super-absorbing product, preferably as a powder, said webs being preferentially bound together by a full width mechanical embossing.

The products of the invention may appear as a roll, of a size suitable for the final use, or as individual folded products, either entangled or not. In this respect, another object of the invention relates to an absorbing paper roll, comprising a strip of paper, consisting of two cellulose wadding webs containing a super-absorbing product, said strip comprising perforations for their tearing along a line, said webs being preferentially bound together by full width mechanical embossing.

Another object of the invention lies in a method for preparing a wiping item or an absorbing composite material, comprising the deposition, preferably in a uniform way, of super-absorbing product, preferably as a powder, between at least two cellulose wadding webs.

The invention also relates to a device for implementing the method, comprising (i) at least two cylinders for assembling both webs and (ii) means for depositing the super-absorbent, preferably in a uniform way.

Other aspects of the invention lie in the uses of materials and items, notably for industrial wiping or in methods for increasing the absorbing power of the cellulose wadding, as it will be explained in the following text. Thus, the invention also lies in the use, for preparing an industrial wiping item, of an absorbing composite material consisting of a super-absorbing product placed between two or more cellulose wadding webs.

As shown, the present invention now describes composite materials and absorbing wiping items comprising a super-absorbing product between at least two cellulose wadding webs.

In the sense of the invention, a super-absorbing product is understood as any compound capable of swelling (or of forming a gel) in the presence of a liquid, without however being solubilized. Such compounds may be of natural or synthetic origin, such as notably alginates, starches, acrylamide, carboxymethyl cellulose, acrylate, either alone or in blends, or their derivatives. The super-absorbing compound used in the present invention preferentially exists as a powder. Indeed, this conditioning provides better dispersion of the product, without significantly affecting the thickness or the texture of the final composite product. It is understood that the super-absorbing product may also be used as a particle or granule, without departing from the present application.

Preferred examples of super-absorbing products which may be used within the framework of the present invention, are cross-linked acrylic acid polymers and cross-linked norbornene polymers. Such super-absorbents are available commercially.

Super-absorbing products have already been implemented in certain absorbing products for body hygiene (diapers, sanitary napkins, etc.). However, they are complex products, which often use fibrous mats, generally combined with synthetic materials. Furthermore, in these products from the prior art, the super-absorbent is generally deposited selectively in well-delimited regions of the composite, which imposes significant technical constraints at the production level. The present invention now describes new absorbing products, more particularly for industrial wiping, essentially including one or more cellulose wadding webs, between which one (or more) super-absorbing products are deposited. Such materials according to our knowledge have never been reported in the prior art.

The wiping products or absorbing materials according to the invention may comprise several thicknesses of cellulose wadding webs, notably 2 to 5 webs. In a preferred embodiment, the products according to the invention consist of two cellulose wadding webs. The use of two webs is simpler and more economical, industrially, and the introduction of a super-absorbing product in this type of product, according to the present invention, provides considerable increase in the absorbing power (300%, or even more). Thus, a more particular object of the present invention lies in a wiping item or an absorbing composite material, characterized in that it comprises two cellulose wadding webs between which a super-absorbing product is placed.

The cellulose wadding webs (or sheets or leaves) implemented within the framework of the present invention, preferentially in majority consist of cellulose wadding. Preferably, they comprise more than 60% of cellulose wadding, even more preferentially more than 75% of cellulose wadding. In a particular embodiment, they entirely consist of cellulose wadding. Other agents or products may enter the web(s) composition according to the invention, such as notably agents for increasing the wet resistance of the webs. As an example, the use of resins, for example synthetic resins (typically epichlorhydrin resins) may notably be mentioned, which provide protection of the interfibre bonds of the webs and improves their resistance against the disintegrating action of water. Such agents or resins generally represent less than 1% by weight of the web composition. On the other hand, the webs may contain other materials or fibers used in the paper or textile industry. Moreover, the cellulose wadding webs may consist of virgin or recycled fibers. Generally webs with 12-60 g/m² per web may be implemented, more generally 16-40 g/m². The width and the length of the webs may be adapted by one skilled in the art according to the contemplated use. In particular, these may be strips wound on rolls or individual sheets.

The amounts of super-absorbent used may also be adapted by one skilled in the art according to the intended use, the used super-absorbent, the number of webs, etc. Typically, the products and articles according to the invention comprise from 1 to 15 g/m² by weight of the super-absorbent. More preferentially, they include 1-8 g/m² by weight of super-absorbent and even more preferentially 4-6 g/m² by weight of super-absorbent.

The super-absorbent may be maintained between the webs in different ways. Generally, the super-absorbent is maintained by mechanical embossing of the webs. Preferentially this is full width embossing, i.e. affecting the whole of the surface of the web, and not simply certain strips of the latter (knurling). In a particular embodiment, the super-absorbent is maintained by mechanical and chemical embossing of the webs. Chemical embossing notably comprises the use of adhesives, notably biological and/or synthetic glues. As an example, a starch-based glue may be mentioned.

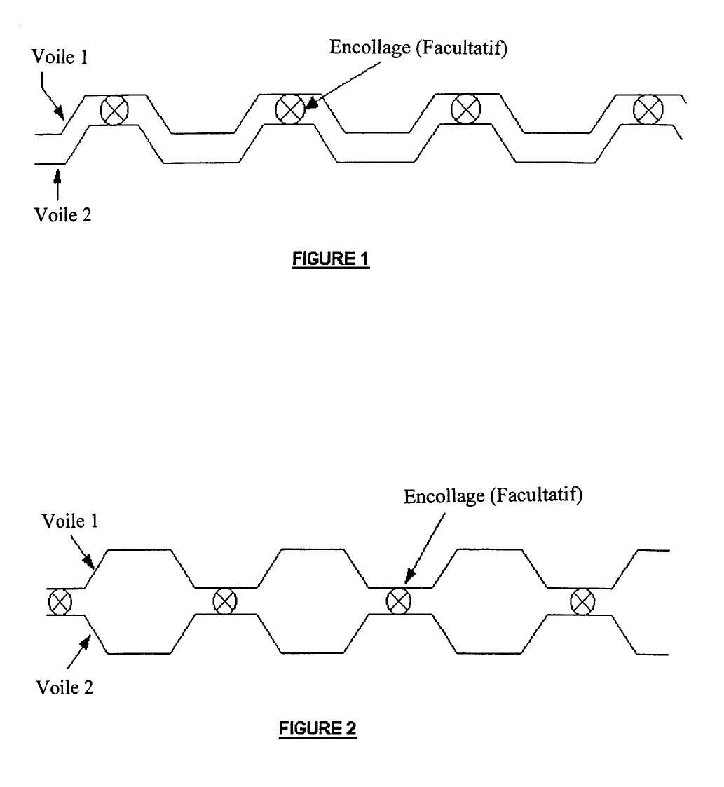

A particular embodiment comprises the full width embossing of the nested type, preferably in presence of a glue: this type of embossing is illustrated in FIG. 1.

Another embodiment is a point-to-point embossing as illustrated in FIG. 2.

A particular embodiment of the present invention therefore relates to a wiping article, comprising at least two cellulose wadding webs between which a super-absorbing powder product has been placed, the webs being mechanically bound to one another by full width embossing, preferably of the nested type, even more preferentially, combined with a chemical binder. As indicated hereinbefore, the wiping items according to the invention are generally free of fibrous mats and/or of any other synthetic materials encountered in body hygiene items.

The products and materials according to the invention may be prepared in different ways. One of the advantages of these products also lies in the ease with which the method may be industrialized, as machines or parts of combined machines, currently used in the final stage of the making of the cellulose wadding (for a semi-manufactured product), or machines or parts of machines currently used in the processing of cellulose wadding (for finished products) may be implemented.

Therefore, an object of the invention also relates to a method for preparing a wiping item or an absorbing material as described hereinbefore, comprising the deposition, preferably in a uniform way, of the super-absorbing product between at least two cellulose wadding webs. Generally, the method of the invention comprises a further step for binding the webs, for maintaining the whole or part of the super-absorbing product.

Another object of the invention relates to a method for increasing the absorbing power of the cellulose wadding for various liquids, comprising the deposition, preferably in a uniform way, of (a) super-absorbing powdery product(s) between two or several cellulose wadding webs.

Of course, in the implementation of the method, the super-absorbing product(s) may be selected according to the liquid to be absorbed, and their amount is adapted according to the desired use.

According to a preferred embodiment, deposition of the super-absorbent is achieved via a dry route. It may notably be achieved through spraying (with air or compressed gas) or by electrostatic coating, spraying being a preferred method. For this embodiment, spraying is for example achieved between both webs, upon their assembly and the achieved coating is maintained by embossing as indicated hereinbefore, preferably by binder embossing of the nested type. This method advantageously enables machines currently used in the processing of cellulose wadding, to be used after setting up in the machine, means for spraying the super-absorbent. In addition, spraying provides a uniform coating of the super-absorbent, and control of the deposited amount may be achieved by changing the flow rate or the pressure of the carrier gas.

Of course, any other coating means may be used.

When more than two webs are used, the super-absorbing product may be introduced either in between each web, or in between only some of them, or even only in between two of them.

A preferred embodiment of the method of the invention comprises the coating via a dry route of a super-absorbing product existing as a powder between two or several cellulose wadding webs, and the maintaining of the product thus deposited by generating a mechanical bond between the webs, optionally reinforced by a partial sizing.

The invention in addition relates to a device for producing absorbing composite materials as described hereinbefore, comprising (i) at least two cylinders for assembling two cellulose wadding webs and (ii) means for depositing the super-absorbent, preferably in a uniform way. These assembly and coating means are arranged so as to provide the maintaining of the super-absorbent product in the final composite material. Means for depositing the super-absorbent may be a (ramp of) spraying nozzle(s), or cylinders for electrostatic deposition. Moreover, at least one of the cylinders for the assembly is engraved in order to enable the making of a mechanical embossment of the webs.

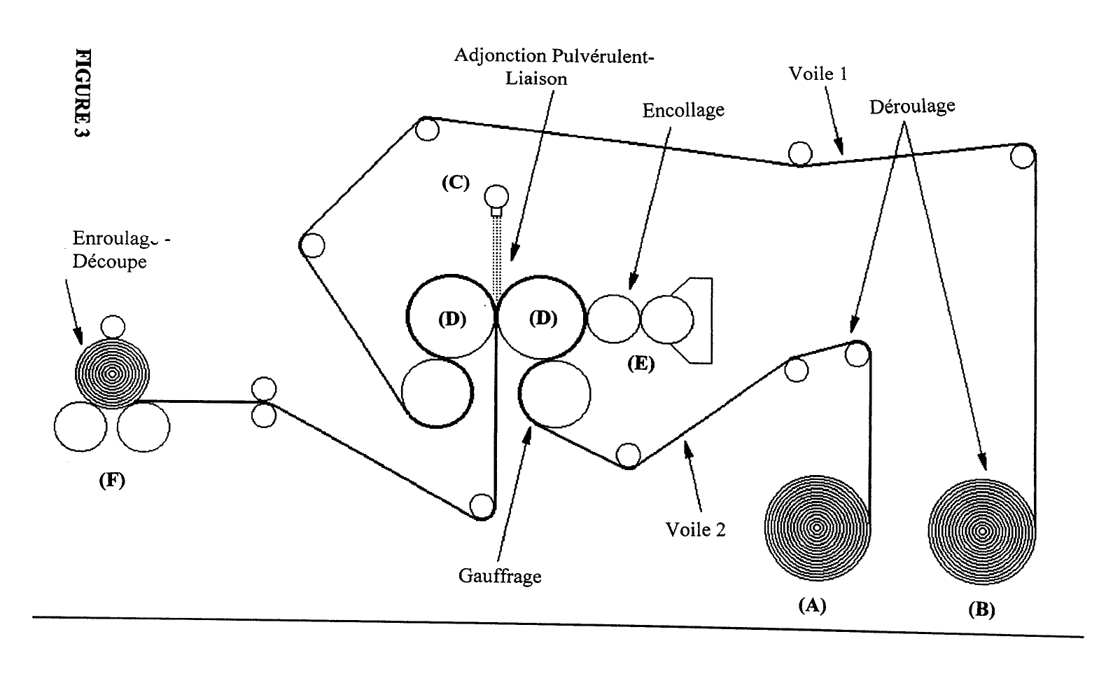

A specific embodiment of the invention is illustrated in FIG. 3. According to this alternative, two cellulose wadding webs are unwound from rolls (A) and (B), thereby providing a separation between both webs. The powder super-absorbing product is then deposited or projected between these webs (on one of the webs, on both of them or in the separation area of the webs), by using spraying nozzles distributed over the width (C). A mechanical link (through points) is then made between the webs in order to maintain the whole or part of the super-absorbing product in place. The latter for example may be accommodated in the cells left by the mechanical joint. The mechanical link is preferentially achieved by having the webs compressed in between both cylinders (D), at least one of them being engraved in order to obtain a local extension of the web, providing a joint (generally a point joint). The joint may in addition be reinforced by pre-sizing the points obtained by embossing, by means of the cylinder (E). After this linking, the product is either wound onto large dimension spools in order to obtain a semi-manufactured product which may be used as a raw material for a subsequent processing stage, or wound onto spools which may directly be used by the users (F). The composite product may also, by using a suitable processing device, be cut up into sheets either folded or not, shown as either entangled or not.

Specific examples of the composite products according to the invention are mentioned in the table hereafter, as well as their absorbing properties.

Product according to the invention

| | Weight (g/m²) | | |
|---|---|---|---|
| | 32.22 | | |
| | Test 1 | Test 2 | Average |
| Mass of the sample (g) | 7.30 | 7.30 | 7.30 |
| Mass of absorbed water (g) | 206.30 | 204.60 | 205.45 |
| Wetting time (s) | 8.0 | 8.0 | 8.0 |

Cellulose wadding alone

| | Weight (g/m²) | | |
|---|---|---|---|
| | 28.02 | | |
| | Test 1 | Test 2 | Average |
| Mass of the sample (g) | 7.30 | 7.30 | 7.30 |
| Mass of absorbed water (g) | 67.84 | 67.97 | 67.90 |
| Wetting time (s) | 10.0 | 10.5 | 10.25 |

The products and items of the invention are particularly adapted for industrial wiping, notably in medical centers (hospitals, morgues, laboratories, etc.), equipment rooms, garages, factories, warehouses, in various industrial fields where liquid absorption is primordial (automobile, aeronautics, printing, etc.), in the transport of fruits and vegetables. The advantages of the invention are numerous, and notably the manufacturing of inexpensive strongly absorbing composite products, which may be produced by means of conventional facilities, economically and industrially.

1. Wiping item, characterized in that it comprises at least two cellulose wadding webs between which a powdery super-absorbing product is placed, the webs being mechanically bound to each other by full width embossing, preferably of the nested type, even more preferentially combined with a chemical binder.

2. The wiping item according to claim 1, characterized in that it comprises from 1 to 15 g/m² by weight of super-absorbent.

3. The wiping item according to any of claims 1 or 2, characterized in that it comprises from 2 to 5 webs, preferably 2 webs, preferably webs with 12 to 60 g/m².

4. The wiping item according to any of claims 1 to 3, characterized in that super-absorbing products are selected from cross-linked acrylic acid polymers and cross-linked norbornene polymers.

5. Use for preparing an industrial wiping item, of an absorbing composite material consisting of a super-absorbing product placed between two or several cellulose wadding webs.

6. An absorbing paper roll comprising a paper strip consisting of two cellulose wadding webs containing a super-absorbing product, said strip comprising delimited portions for their tearing along a line.

7. A method for preparing a wiping item comprising the deposition, preferably in a uniform way, of super-absorbing product between at least two cellulose wadding webs, and a step for mechanically binding the webs over a full width.

8. The method according to claim 7, characterized in that the deposition is performed via a dry route, preferably by spraying.

9. The method according to claim 7 or 8, characterized in that the mechanical bond is combined with a chemical binder.

10. A method for increasing the absorbing power of the cellulose wadding for various liquids comprising the deposition in a uniform way, of (a) super-absorbing powdery product(s) between two or more cellulose wadding webs, and the full width mechanical bonding of said webs.

11. A device for implementing the method according to any of claims 7 to 10, comprising (i) at least two cylinders (D) for assembling both webs by full width embossing and (ii) means (C) for depositing the super-absorbent preferably in a uniform way.

12. The device according to claim 11, characterized in that the means for depositing the super-absorbent are represented by a spray nozzle (C).

13. The device according to claim 11 or 12, characterized in that at least one of the cylinders (D) for the assembly is engraved in order to enable mechanical embossing of the webs to be achieved.
